(19) United States
(12) Patent Application Publication
(10) Pub. No.: US 2020/0042134 A1
(43) Pub. Date: Feb. 6, 2020

(54) TOUCH DISPLAY DEVICE AND CONTROLLER USED IN THE SAME

(71) Applicant: NOVATEK MICROELECTRONICS CORP., HsinChu (TW)

(72) Inventors: Yu-Chung LIN, Taoyuan City (TW); He-Wei HUANG, Hsinchu City (TW); Chun-Ching HUANG, Zhubei City (TW); Yao-Ren FAN, Zhubei City (TW)

(21) Appl. No.: 16/357,556

(22) Filed: Mar. 19, 2019

Related U.S. Application Data
(60) Provisional application No. 62/713,016, filed on Aug. 1, 2018.

(51) Int. Cl. G06F 3/041; G06F 3/038; H04W 72/12; H04W 56/00

(52) U.S. Cl. CPC G06F 3/0416; G06F 3/038; G06F 2203/04106; H04W 56/003; H04W 72/1273

(57) ABSTRACT

A controller and a touch display device are disclosed. The controller used in a touch display device is configured to perform: transmitting a first uplink signal to an input device in a time slot of a frame: and transmitting one or more second uplink signal in one or more time slots of the frame to cause the input device to transmit one or more downlink signals in response to each of the one or ore second uplink signals.

This application claims the benefit of U.S. provisional application Ser. No. 62/713,016, filed Aug. 1, 2018, the subject matter of which is incorporated herein by reference.

### BACKGROUND OF THE INVENTION

### Field of the Invention

The invention relates to a display device and a controller used in display devices.

### Description of the Related Art

Touch display devices are widely used in various electronic products such as smart phones, tablets and so on. Based on different sensing mechanisms, some touch display devices can support using an active pen as an input device in addition to fingers. To support an active pen, such a touch display devices should be able to transmit uplink signals to the active pen and receive downlink signals from the active pen. However, since there may be an error between the clocks of the touch display device and the active pen, the timing of transmitting/receiving the uplink/downlink signals may be difficult to synchronize. Therefore, how to design a better signal transmission frame structure between the touch display device and the active pen is an important issue for improving the quality of touch display devices.

### SUMMARY OF THE INVENTION

An embodiment of the present invention discloses a controller, used in a touch display device. The controller is configured to perform: transmitting a first uplink signal to an input device in a time slot of a frame: and transmitting one or more second uplink signal in one or more time slots of the frame to cause the input device to transmit one or more downlink signals in response to each of the one or more second uplink signals.

Another embodiment of the present invention discloses a touch display device including a display module, a touch module and a controller. The controller is coupled to the display module and the touch module, and is configured to perform: transmitting a first uplink signal to an input device in a time slot of a frame: and transmitting one or more second uplink signal in one or more time slots of the frame to cause the input device to transmit one or more downlink signals in response to each of the one or more second uplink signals.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a touch display device according to an embodiment of the present invention.

FIG. 2 shows a signal timing diagram of a touch display device according to an embodiment of the present invention.

FIGS. 3A and 3B show signal timing diagrams of a touch display device according to other embodiments of the present invention.

FIG. 4 shows a signal timing diagram of a touch display device according to yet another embodiment of the present invention.

FIG. 5 shows a signal timing diagram of a touch display device according to yet another embodiment of the present invention.

### DETAILED DESCRIPTION OF THE INVENTION

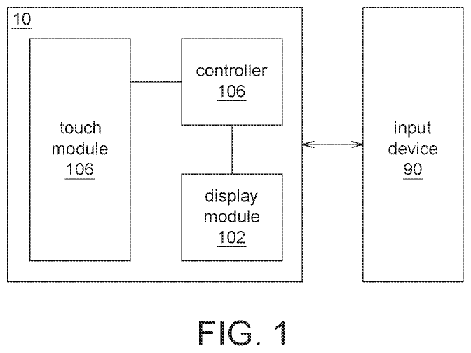

Referring to FIG. 1, FIG. 1 shows a block diagram of a touch display device according to an embodiment of the present invention. The touch display device 10 includes a display module 102, a touch module 104 and a controller 106. The display module 102 may include a display panel for displaying. In an embodiment, the display panel may be a LED display panel, an OLED display panel and so on. The touch module 104 may include a touch panel for sensing touch signals from fingers or an input device 90. The controller 106 is coupled to the display module 102 and the touch module 104, and is configured to control the behavior of the display module 102 and the touch module 104, and further to configured to transmit signals to the input device 90. The input device 90 may be an active pen.

In this embodiment, signals from the input device 90 to the touch display device 10 is defined as downlink signals, and signals from the touch display device 10 to the input device 90 is defined as uplink signals.

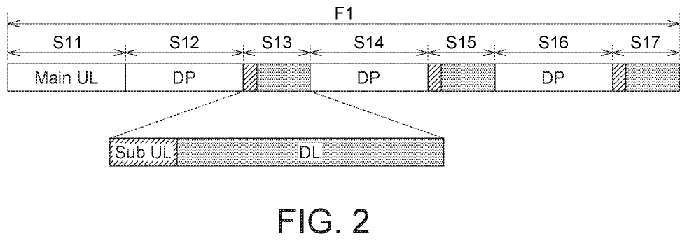

Referring to FIG. 2, FIG. 2 shows a signal timing diagram of a touch display device according to an embodiment of the present invention. This timing diagram shows the signal timing of the touch display device 10. A frame F1 includes a number of time slots S11-S17. In time slot S1, “Main UL” refers to a first uplink signal transmitted from the controller 106 of the touch display device 10 to the input device 90. The first uplink signal may include the length of a downlink signal and the amount of the downlink signal(s) that the input device 90 is required to transmit. In another embodiment, the first uplink signal may further include a preamble for the input device 90 to find the touch display device 10, connection information for the input device 90 to establish a connection with the touch display device 10, a modulation type and a frequency for the input device 90 to transmit downlink signals, a selection for selecting a mode from various modes of the input device 90, error correcting codes (ECC) such as Cyclic redundancy check (CRC) code and/or any information if needed. In time slots S12, S14, S16, “DP” refers to a display term of the touch display device 10. During the display term, the controller 106 of the touch display device 10 may enable the display module 102 to output display signals and may disable the touch module 104. That is, during the display term, the controller 106 may not transmit uplink signals to the input device 90 and receive downlink signals from the input device 90. In time slots S13, S15, S17, “sub UL” refers to a second uplink signal transmitted from the controller 106 to the input device 90. The second uplink signal is configured to notify the input device 10 of the timing at which the downlink signal to be transmitted. In an embodiment, the second uplink signal may be a signal with a fixed frequency and free of including any information. In another embodiment, the second uplink signal may include a device ID of the input device 90 (if there is one or more other input devices), a selection for selecting a mode from various modes of the input device 90, ECC such as CRC code, a requirement for the content of the downlink signal (e.g., re-transmission of a previous downlink signal) and/or any information if needed. “DL” refers to a downlink signal transmitted from the input device 90 to the controller 106. The input device 90 transmits a downlink signal only when said second uplink signal is received. That is, in this embodiment, after a first uplink signal has been transmitted from the controller 106 to the input device 90, the controller 106 is configured to transmit one or more second uplink signals to the input device 90 to cause the input device 90 to transmit one or more downlink signal to the touch display device 10 in response to each of the one or more second uplink signals. More specifically, in this embodiment, a time slot includes one second uplink signal and one downlink signal, and one downlink signal is corresponding to one second uplink signal.

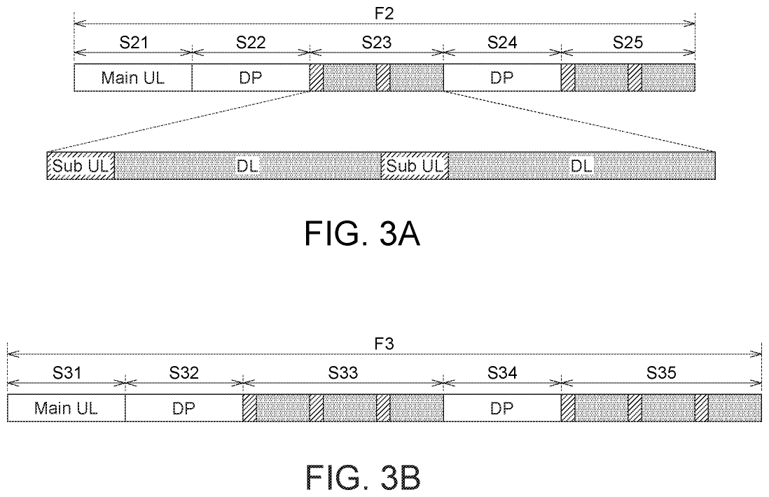

Referring to FIGS. 3A and 3B, FIGS. 3A and 3B show signal timing diagrams of a touch display device according to other embodiments of the present invention. In FIG. 3A, a frame F2 includes a number of time slot S21-S25, Each of the time slots S23, S25 may include two second uplink signals and two downlink signals, and the downlink signals are corresponding to the second uplink signals respectively. In FIG. 3B, a frame F3 includes a number of time slots S31-S35, Each of the time slots S33, S35 may include three second uplink signals and three downlink signals, and the downlink signals are corresponding to the second uplink signals respectively. That is, the controller 106 may transmit two or more second uplink signals in a single time slot, and the input device 90 may transmit a downlink signal in response to each of the second uplink signals. In an embodiment, the amount of the second uplink signals to be transmitted in a single time slot may be defined in the first uplink signal. In this case, the first uplink signal may include the information of the amount of the second uplink signals to be transmitted in a single time slot. When the input device 90 receives the first uplink signals from the controller 106, the input device 90 may know the amount of downlink signal should be transmitted in a single time slot in response to the second uplink signals.

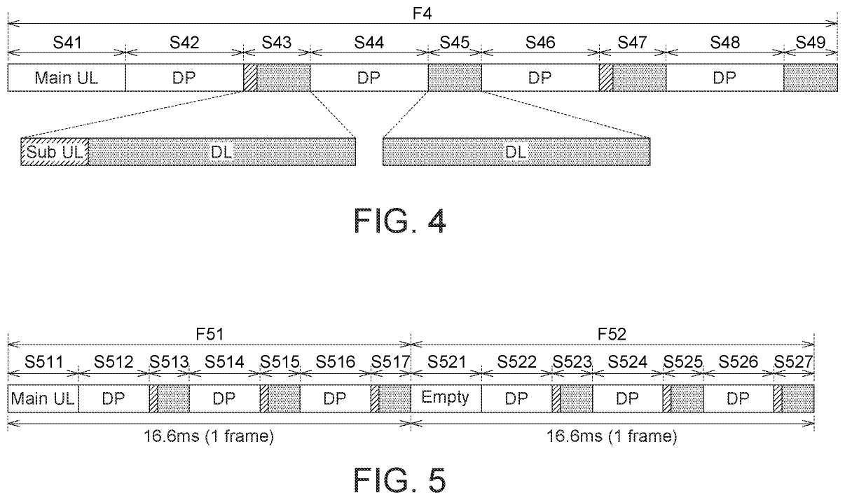

Referring to FIG. 4, FIG. 4 shows a signal timing diagram of a touch display device according to yet another embodiment of the present invention. In FIG. 4, a frame F4 includes a number of time slots S41-S49. Each of time slots S43, S47 includes one second uplink signal and one downlink signal. Each of time slot S45, S49 includes one downlink signal without any second uplink signal. In this embodiment, the controller 106 transmits a second uplink signal in the time slot S43, and the input device 90 transmits two downlink signals in the time slots S43, S45 respectively, in response to the second uplink signal in the time slot S43. The controller 106 transmits a second uplink signal in the time slot S47, and the input device 90 transmits two downlink signals in the time slots S47, S49 respectively, in response to the second uplink signal in the time slot S47. That is, two downlink signals in two different time slots are corresponding to one second uplink signal. In this case, the amount of time slots for downlink signal corresponding to a single second uplink signal may be defined in the first uplink signal by the controller 106, According to the received first uplink signal, the input device 90 may transmit the downlink signals in the designated amount of the time slots for downlink signal in response to a single second uplink signal.

Referring to FIG. 5, FIG. 5 shows a signal timing diagram of a touch display device according to yet another embodiment of the present invention. In FIG. 5, a frame F51 includes a number of time slots S511-S517, and a frame F52 includes a number of time slots S521-S527. In this embodiment, the second uplink signals and the downlink signals in two or more frames are corresponding to a single first uplink signal. In this case, the amount of frames corresponding to a single first uplink signal may be defined in the first uplink signal by the controller 106.

Noted that, the first uplink signal and the second uplink signal may be transmitted by any modulation and any frequency. Furthermore, the length of the first uplink signal and the second uplink signal may be determined according to actual needs.

In addition, the input device 90 may be configured to reset when no second uplink signal (e.g., for several frames after a first uplink signal is received) is received. When the input device 90 is reset, the controller 106 may be required to transmit another first uplink signal to activate the input device 90 to be ready for transmitting downlink signals.

With the second uplink signal, the input device 90 may know a specific time for transmitting the downlink signal without relying on accurate clock synchronization with the touch display device 10.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A controller, used in a touch display device, the controller is configured to perform:
transmitting a first uplink signal to an input device in a time slot of a frame; and
transmitting one or more second uplink signal in one or more time slots of the frame to cause the input device to transmit one or more downlink signals in response to each of the one or more second uplink signals.

2. The controller according to claim 1, wherein the controller transmits a single second uplink signal in a single time slot to cause the input device to transmit a single downlink signal in the same time slot.

3. The controller according to claim 1, wherein the controller transmits two or more second uplink signals in a single time slot to cause the input device to transmit two or more downlink signals in the same time slot, and the two or more downlink signals are transmitted in response to the two or more second uplink signal respectively.

4. The controller according to claim 1, wherein in response to each of the one or more second uplink signals the input device is required to transmit one or more downlink signals in different time slots of the frame.

5. The controller according to claim 1, wherein the first uplink signal is further corresponding to subsequent one or more frames.

6. The controller according to claim 1, wherein the first uplink signal includes a length of a single downlink signal and an amount of the downlink signal(s) that the input device is required to transmit.

7. The controller according to claim 1, wherein each of the one or more second uplink signals is a signal with fixed frequency and free of including any information.

8. The controller according to claim 1, wherein each of the one or more second uplink signals includes a device ID of the input device, a selection for selecting a mode from various modes of the input device, error correcting code and/or a requirement for the content of the corresponding downlink signal(s).

9. A touch display device, comprising:
a display module;
a touch module; and
a controller, coupled to the display module and the touch module, and configured to perform:
transmitting a first uplink signal to an input device in a time slot of a frame; and
transmitting one or more second uplink signal in one or more time slots of the frame to cause the input device to transmit one or more downlink signals in response to each of the one or more second uplink signals.

10. The touch display device according to claim 9, wherein the controller transmits a single second uplink signal in a single time slot to cause the input device to transmit a single downlink signal in the same time slot.

11. The touch display device according to claim 9, wherein the controller transmits two or more second uplink signals in a single time slot to cause the input device to transmit two or more downlink signals in the same time slot, and the two or more downlink signals are transmitted in response to the two or more second uplink signal respectively.

12. The touch display device according to claim 9, wherein in response to each of the one or more second uplink signals the input device is required to transmit one or more downlink signals in different time slots of the frame.

13. The touch display device according to claim 9, wherein the first uplink signal is further corresponding to subsequent one or more frames.

14. The touch display device according to claim 9, wherein the first uplink signal includes a length of a single downlink signal and an amount of the downlink signal(s) that the input device is required to transmit.

15. The touch display device according to claim 9, wherein each of the one or more second uplink signals is a signal with fixed frequency and free of including any information.

16. The touch display device according to claim 9, wherein each of the one or more second uplink signals includes a device ID of the input device, a selection for selecting a mode from various modes of the input device, error correcting code and/or a requirement for the content of the corresponding downlink signal(s).
